(19) United States
(12) Patent Application Publication
(10) Pub. No.: US 2018/0048622 A1
(43) Pub. Date: Feb. 15, 2018

(54) Encrypted Router for Securing Public Network Connections

(71) Applicants: Anthony Gaitatzis, Walnut, CA (US); Chris Cassano, San Francisco, CA (US)

(72) Inventors: Anthony Gaitatzis, Walnut, CA (US); Chris Cassano, San Francisco, CA (US)

(21) Appl. No.: 15/236,425

(22) Filed: Aug. 13, 2016

(51) Int. Cl. H04L 29/06; H04W 12/08

(52) U.S. Cl. CPC H04L 63/029; H04L 63/0272; H04L 63/0209; H04L 63/0464; H04W 12/08

(57) ABSTRACT

Conventionally, network-accessible devices (e.g., cellular phones, tablets, personal computers) have been able to establish virtual point-to-point connections between a local modem and a virtual private network (VPN) across a public network, such as the Internet. However, providers often capitalize on this “open” connection and retrieve information regarding a user's browsing history. Moreover, some public network firewalls, which identify the encryption level of the user's communication(s), may prevent the user from accessing the VPN and other websites. An encrypted router can passively secure the user's connection to the Internet by tunneling between the local modem and the VPN. The encrypted router also obfuscates firewalls configured to flag communication(s) having high encryption levels by re-wrapping the communication(s) with a lower encryption level.

### FIELD OF THE INVENTION

Various embodiments concern network access points. More specifically, various embodiments relate to systems and methods for anonymizing and securing public network connections initialized by a wireless device.

### BACKGROUND

Conventionally, network-accessible devices (e.g., cellular phones, tablets, personal computers) have been able to establish virtual point-to-point connections between a local modem and a virtual private network (VPN) across a public network, such as the Internet. However, providers often capitalize on this “open” connection and retrieve information regarding a user's network traffic or stored data. Moreover, some public network firewalls, which identify the encryption level of the user's communication(s), may prevent the user from accessing the VPN and other websites.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIG. 1 is a generalized block diagram depicting components in a public communication system as may traditionally occur.

FIG. 2 is a generalized block diagram depicting components in an encryption system for communicating over a public network according to various embodiments.

FIG. 3 is a block diagram with exemplary components of a system for securing public network connections as may occur in some embodiments.

FIG. 4 is a flow diagram depicting aspects of a process for securing a public network connection as may occur in some embodiments.

FIG. 5 is a block diagram illustrating an example of a computer system in which at least some operations described herein can be implemented according to various embodiments.

The figures depict various embodiments described throughout the Detailed Description for purposes of illustration only. While specific embodiments have been shown by way of example in the drawings and are described in detail below, the invention is amenable to various modifications and alternative forms. The intention, however, is not to limit the invention to the particular embodiments described. Accordingly, the claimed subject matter is intended to cover all modifications, equivalents, and alternatives falling within the scope of the invention as defined by the appended claims.

### DETAILED DESCRIPTION

Various embodiments are described herein that relate to systems for securing public network (e.g., Internet) connections. More specifically, various embodiments relate to systems and methods for passively securing a user's connection to the public network by tunneling between an encrypted router and a secure virtual private network (VPN) configured to act as a proxy. The secure VPN may also be configured to obfuscate a firewall by re-wrapping communications with a lower encryption level less likely to be blocked by the firewall.

As will be described more in-depth below, the techniques introduced herein can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Topology Overview

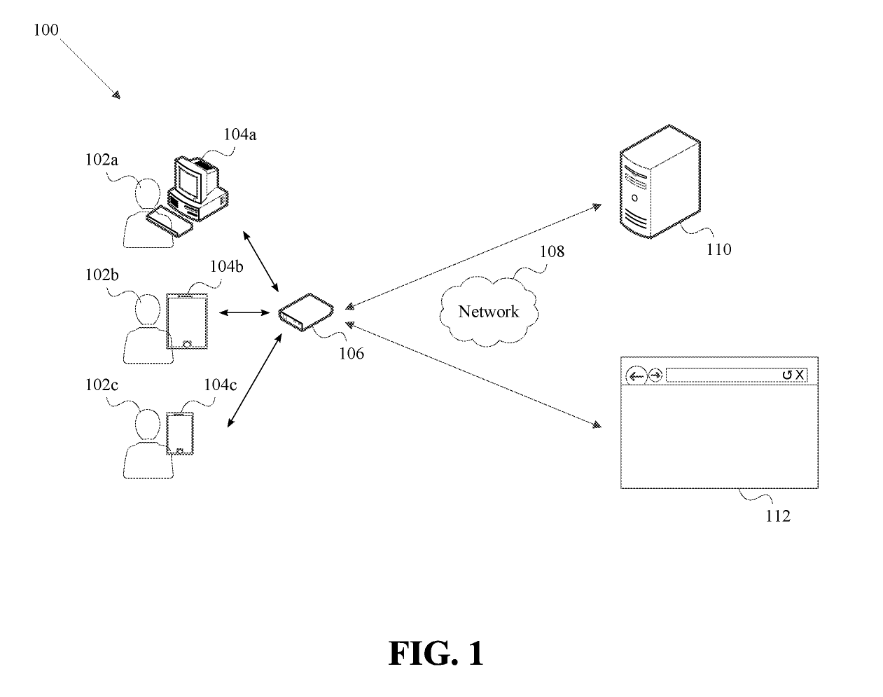

FIG. 1 is a generalized block diagram depicting components in a public communication system 100 as may traditionally occur. Here, users 102a-c employ network-accessible devices 104a-c to access virtual private networks (VPNs) 110, websites 112, etc., over a public network 108.

The network-accessible devices 104a-c can be a server, a personal computer (PC), a tablet (e.g., iPad®), a laptop computer, a personal digital assistant (PDA), a cellular telephone, a smartphone (e.g., iPhone®, Blackberry®), a console, a gaming device, a music player, another portable hand-held device, or any other machine or device (e.g., watches, appliances) capable of accessing a public network 108. The public network 108, meanwhile, represents any connection to the Internet including, for example, a 3G/4G network connection, Ethernet (i.e., local area networks (LANs) and metropolitan area networks (MANs)), any wireless local area network (e.g., WiFi), a wide area network, a point-to-point dial-up connection, etc.

The network-accessible devices 104a-c can connect to a cable modem (“modem”) 106. The connection can be wired or wireless. Oftentimes, the network-accessible devices 104a-c connect to the modem 106 via a router. The modem 106 is connected to an Internet service provider (“ISP”), which allows each of the network-accessible devices 104a-c to connect to the network 108. But the relationship between the network-accessible devices 104a-c and the ISP is unsecure in the sense that an ISP can access information regarding what each of the network-accessible devices 104a-c are accessing, browsing, etc.

Users 102a-c have previously attempted to mask their activity a number of ways. For example, some security platforms for utilize The Onion Router (“TOR”), a software project that enables anonymous communications by making it more difficult for Internet activity to be traced back to the originator (i.e., user of the device). TOR attempts to conceal users' identities and online activity by separating identification and routing. More specifically, TOR encrypts and randomly bounces communications through a network of relays run by volunteers around the globe once a request is submitted by the user.

However, users 102a-c that access a public network 108 in this manner are also at risk of being blocked by firewalls designed to flag certain (e.g., highly encrypted) communications. Consequently, the firewall may prevent the user 102a-c from accessing a VPN 110 and certain websites 112. TOR-based security platforms, meanwhile, are unable to circumvent the firewall because they simply re-direct Internet traffic through various other relays rather than re-structure the communication itself.

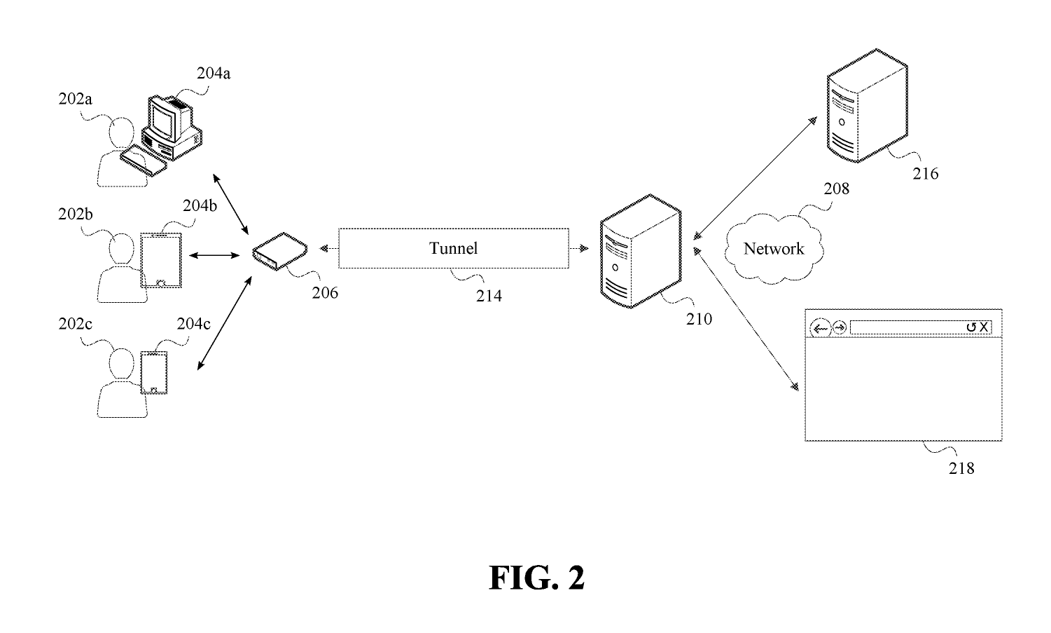

FIG. 2 is a generalized block diagram depicting components in an encryption system 200 for communicating over a public network 208 according to various embodiments. Unlike the public communication system 100 of FIG. 1, encryption system 200 allows users 202a-c to securely access VPNs 216, websites 218, etc., using network-accessible devices 204a-c.

In various embodiments, the encryption system 200 includes an encrypted router 206 that is communicatively coupled to a secure VPN 210. While the encrypted router 206 is depicted as wirelessly communicating with the network-accessible devices 204a-c, wired connections are also possible and, in some embodiments, may be preferred.

The encrypted router 206 can be implemented as a hardware device, programmable circuitry appropriately programmed with software and/or firmware, or as a combination of special-purpose and programmable circuitry. For example, the encrypted router 206 can be a power stick (also called a “battery bank”) or self-contained wireless router that acts as a mobile WiFi hotspot. In such embodiments, the encrypted router 206 may include special-purpose hardware components (e.g., a custom Raspberry Pi® board). As another example, the encrypted router 206 may be a mobile application, computer program, or set of computer programs that utilize the existing hardware of a network-accessible device 204a-c. In some embodiments, a combination of existing components, newly-designed

The secure VPN 210 can be a devoted network configured to relay communications, digital requests, etc., submitted by the users 202a-c. More specifically, the secure VPN 210 acts as both a traditional VPN and as a proxy for the network-accessible device(s) 204a-c. Consequently, the secure VPN 210 typically employs one or more software programs to accomplish one or both of these tasks. Collectively, the encrypted router 206 and secure VPN 210 allow a “tunnel” to form between the network-accessible device 204a-c and the desired resource (e.g., VPN 216, website 218). The tunnel blocks access to the user's browsing history and prevents ISPs from tracking the actions of individual users.

Using the secure VPN 210 or another cloud-based computing system, the encryption system 200 can also obfuscate firewalls by re-encrypting certain communications. For example, highly encrypted information can be re-encrypted at a lower level of encryption in order to be allowed through certain firewalls. In short, the encryption system can obfuscate firewalls designed to flag highly encrypted information by rolling the information (i.e., re-encrypting) within an encryption “wrapper” having a lower encryption level.

Once the request for a resource (e.g., VPN 216, website 218) is received by the secure VPN 210, the encryption system 200 can access the resource over the public network 208. However, ISPs (and any other interested entity) are unable to determine which user 202a-c submitted a particular request because the originating source of all requests will be the secure VPN 210.

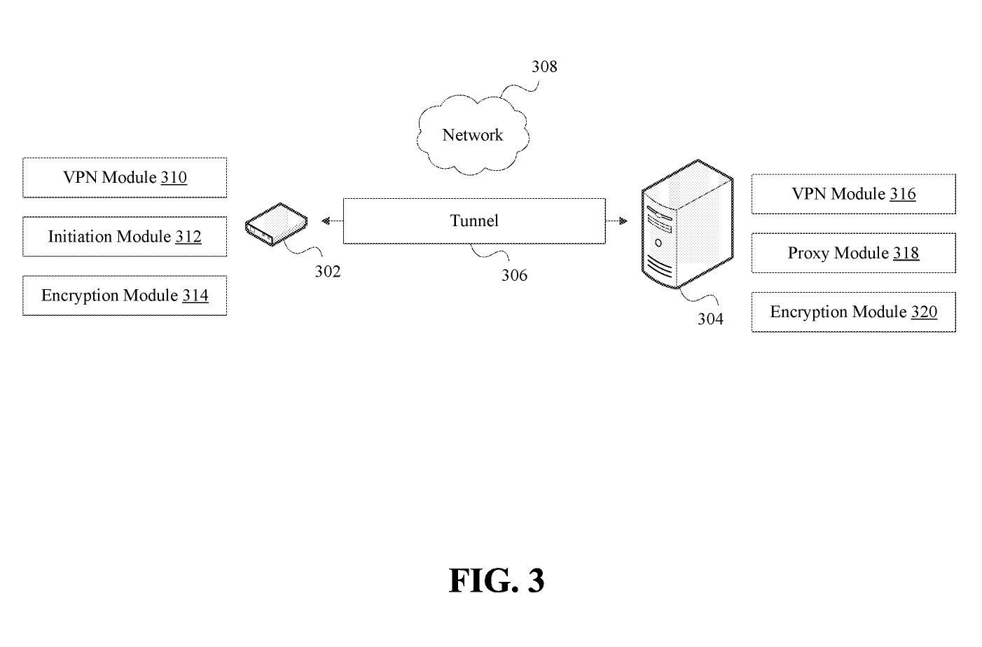

FIG. 3 is a block diagram with exemplary components of a system 300 for securing public network connections as may occur in some embodiments. Other embodiments of the system 300 may include some, all, or none of these modules and components, along with other modules, applications, and/or components. Still yet, some embodiments may incorporate two or more of these modules with a different module.

As described above, an encrypted router 302 can be communicatively coupled to a secure VPN 304 via a tunnel 306 through a public network 308. Tunneling, which involves repackaging the information (also referred to as “traffic” or “traffic data”) into a different form, can be performed using various protocols (e.g., L2TP, GRE).

The encrypted router 302 can include various components modules, instructions, etc. For example, the encrypted router 302 of FIG. 3 includes a VPN module 310, an initiation module 312, and an encryption module 314. The VPN module 310, initiation module 312, or both may be sub-modules of a single communication module configured to transmit and receive information from other sources (e.g., a network-accessible device, the secure VPN 304). More specifically, the VPN module 310 can receive, (re)format, transmit, etc., information according to one or more VPN/tunneling protocols, such as IPsec, L2TP, and SSL.

The initiation module 312 can initiate the connection with the secure VPN 304 and ensure the connection remains stable. In some embodiments, the initiation module 312 presents login credentials to the secure VPN 304, which permits access, associates the communication session with a particular user, etc. The encrypted router 302 may also include an encrypted module 314 that is configured to encrypt and/or decrypt information transmitted between the encrypted router 302 and the secure VPN 304. Other modules may also be present, such as a wireless communication module that allows network-accessible devices to wirelessly connect to the encrypted router 302.

The secure VPN 304, meanwhile, can include similar and/or different modules. For example, the secure VPN 304 depicted in FIG. 3 includes a VPN module 316, a proxy module 318, and an encryption module 320. VPN module 316, which may be largely similar to VPN module 310 of the encrypted router 302, can support one or more VPN/tunneling protocols used to transmit information between the encrypted router 302 and the secure VPN 304. The proxy module 318 can be configured to transmit requests for resources (e.g., VPNs, websites) received by the secure VPN 304.

As described above, a user typically submits a request on a network-accessible device. The network-accessible device transmits the request to the encrypted router 302, which then passes the request to the secure VPN 304 using the tunnel 306. Because the request appears to originate from the secure VPN 304 rather than an individual network-accessible device, the secure VPN 304 acts as a proxy for transmitting and receiving digital information. In some embodiments, an encryption module 320 is configured to encrypt or re-encrypt the request before transmitting the request over a public network 308. For example, the request may be “wrapped” inside a protocol (e.g., HTTP) that firewalls do not block. Re-wrapping obfuscates the firewall and allows the request to pass through a firewall that would normally block the request.

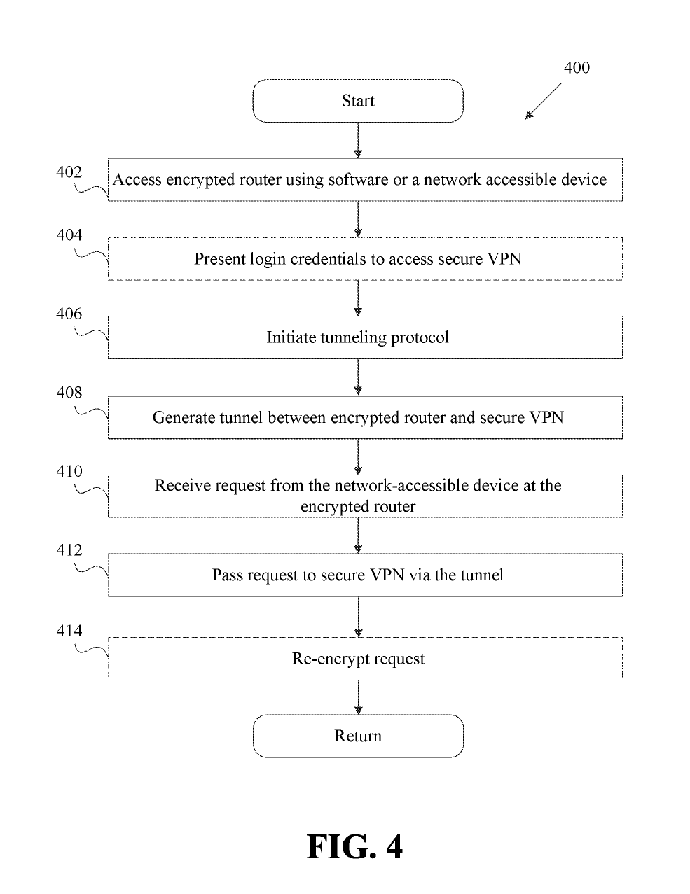

FIG. 4 is a flow diagram depicting aspects of a process 400 for securing a public network connection as may occur in some embodiments. Various embodiments may include all or some of these steps, which can be performed in any order unless physically impossible.

At block 402, a user accesses an encrypted router using a network-accessible device. The network-accessible device (e.g., cellular phone, tablet, computer) can access the encrypted router through a wired or wireless connection. In some embodiments, a secure VPN may require login credentials be presented in order to permit access, as shown at block 404. The user may manually input the credentials or the network-accessible device and/or encrypted router may be configured to do so automatically. That is, the network-accessible device and/or encrypted router may store login credentials for one or more users that entered automatically upon the user initiating a connection.

At block 406, the encrypted router, secure VPN, or both can initiate the tunneling according to one or more tunneling protocols. Generally, tunneling requires little, if any, input from the user. Instead, the network-accessible device, encrypted router, and secure VPN can be configured to automatically initiate and generate the tunnel. At block 408, the tunnel is generated between the encrypted router and the secure VPN. The “tunnel” is essentially an extension of the secure VPN network directly to the encrypted router. Consequently, requests for information can be delivered from the encrypted router directly to the secure VPN without traversing a public network.

At block 410, a request for information is received from the network-accessible device at the encrypted router and, at block 412, the encrypted router can pass the request to the secure VPN via the tunnel. Once received by the secure VPN, the request can be relayed over a public network (i.e., secure VPN acts as a proxy for the network-accessible device). Because the request appears to originate from the secure VPN, the user's identity remains hidden (e.g., from ISPs).

In some embodiments, the secure VPN encrypts or re-encrypts the request prior to transmitting over the public network, as shown at block 414. The secure VPN may re-encrypt the request, for example, if the secure VPN determines the request is substantially likely to be blocked by a firewall. In such instances, the secure VPN can “re-wrap” the request using a transmission/encryption protocol less likely to be blocked by the firewall (e.g., HTTP).

### Computer System

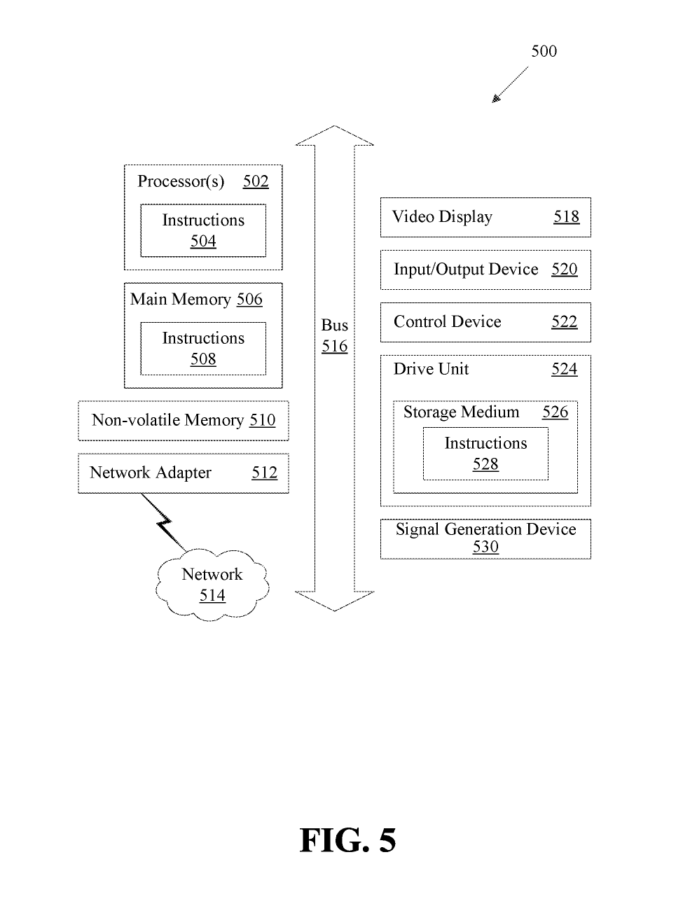

FIG. 5 is a block diagram illustrating an example of a computing system 500 in which at least some operations described herein can be implemented. The computing system may include one or more central processing units (“processors”) 502, main memory 506, non-volatile memory 510, network adapter 512 (e.g., network interfaces), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents any one or more separate physical buses, point to point connections, or both connected by appropriate bridges, adapters, or controllers. The bus 516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 500 operates as a standalone device, although the computing system 500 may be connected (e.g., wired or wirelessly) to other machines. In a networked deployment, the computing system 500 may operate in the capacity of a server or a client machine in a client-server network environment, or as a peer machine in a peer-to-peer (or distributed) network environment.

The computing system 500 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 506, non-volatile memory 510, and storage medium 526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 504, 508, 528) set at various times in various memory and storage devices in a computer, and that, when read and executed by one or more processing units or processors 502, cause the computing system 500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 510, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 512 enables the computing system 500 to mediate data in a network 514 with an entity that is external to the computing device 500, through any known and/or convenient communications protocol supported by the computing system 500 and the external entity. The network adapter 512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A router for securing public network connections, the router comprising:
a communication module configured to communicatively couple the router and a network-accessible device;
a processor operable to execute instructions stored in a memory; and
the memory, which includes the instructions regarding securing public network connections, wherein the instructions are configured to:
receive a request from the network-accessible device;
transmit login credentials to a secure virtual private network (VPN);
cause a tunnel to be generated between the router and the secure VPN across a public network; and
transmit the request to the secure VPN via the tunnel.

2. The router of claim 1, wherein the request designates a desired resource.

3. The router of claim 2, wherein the desired resource is a web address or another VPN.

4. The router of claim 1, wherein the instructions are further configured to:
identify whether the request is highly encrypted and likely to be blocked by a firewall.

5. The router of claim 4, wherein the instructions are further configured to:
flag the request as needing to be re-encrypted if the router identifies the request as being highly encrypted.

6. The router of claim 5, wherein the instructions are further configured to:
cause the secure VPN to transmit the request across the public network; and
cause the secure VPN to re-encrypt the request with a lower level of encryption if the request has been flagged by the router, wherein the lower level of encryption is less likely to be blocked by the firewall.

7. A method for securing public network connections, the method comprising:
providing an encrypted router, the encrypted router configured to be accessed by a network-accessible device;
communicatively coupling the encrypted router to a secure virtual private network (VPN);
generating a tunnel between the encrypted router and the secure VPN;
allowing a user to submit a request for a resource through the network-accessible device, wherein the request is subsequently transmitted from the network-accessible device to the router; and
causing the router to pass the request to the secure VPN via the tunnel.

8. The method of claim 7, further comprising:
presenting login credentials to access the secure VPN.

9. The method of claim 7, further comprising:
identifying whether the request is highly encrypted and likely to be filtered by a firewall.

10. The method of claim 9, further comprising:
re-encrypting the request with a lower level of encryption if the request is identified as being highly encrypted, wherein the lower level of encryption is less likely to be filtered by the firewall.

11. The method of claim 10, further comprising:
causing the secure VPN to transmit the request across a public network such that an identity of the user submitting the request is masked.
